(19) United States
(12) Patent Application Publication
(10) Pub. No.: US 2026/0247195 A1
(43) Pub. Date: Aug. 20, 2026

(54) Method for enhanced mobility and service continuity based on beam pattern information

(71) Applicant: Continental Automotive Technologies GmbH, Hannover (DE)

(72) Inventors: Andreas ANDRAE, Frankfurt am Main (DE); Rikin SHAH, Langen, Hessen (DE); Reuben GEORGE STEPHEN, Singapore (SG); David GONZALEZ GONZALEZ, Egelsbach, Hessen (DE)

(73) Assignee: Continental Automotive Technologies GmbH, Hannover (DE)

(21) Appl. No.: 19/156,862

(22) PCT Filed: Feb. 14, 2024
(86) PCT No.: PCT/EP2024/053664

§ 371 Date: Aug. 14, 2025

(30) Foreign Application Priority Data
Feb. 15, 2023 (DE) 10 2023 201 308.8

(51) Int. Cl. H04W 24/10

(52) U.S. Cl. CPC H04W 24/10

(57) ABSTRACT

A method of wireless communication by a wireless device for enhanced mobility and service continuity based on beam pattern sharing in the wireless device, the wireless device being connected to a wireless network node and receiving from a mobile node a configuration message. The mobile node broadcasts a node type indicator and beam pattern in the configuration message, and if the wireless device is in an idle/inactive mode, it receives the configuration data as SIB within the configuration message, and if the wireless device is in an active mode, the mobile node provides the wireless device with beam-specific mobility measurement configurations based on beam pattern data within the configuration message.

### CROSS REFERENCE TO RELATED APPLICATIONS

This application is the U.S. National Phase Application of PCT International Application No. PCT/DE2024/053664, filed Feb. 14, 2024, which claims priority to German Patent Application No. 10 2023 201 308.8, filed Feb. 15, 2023, the contents of such applications being incorporated by reference herein.

### FIELD OF THE INVENTION

The present disclosure relates to wireless networks, and more particularly to method and apparatus for enhanced mobility and service continuity based on beam pattern information in a user equipment.

### BACKGROUND OF THE INVENTION

Terrestrial networks may only provide poor or limited coverage in rural and remote areas, e.g., affecting use cases in agriculture, construction, mining, logistics, transportation, utilities. In order to overcome this challenge, 3GPP 5G addressed NR massive MIMO (see FIG. 2, source: RWS-180008, «NR Physical Layer Design: NR MIMO», by Younsun Kim, Samsung), as well as the integrated access and backhauling (IAB) reference architecture, as disclosed by 3GPP TS 23.501 Release 18 (illustrated by FIG. 3) which is considered as baseline for aerials/unmanned aerial vehicles (UAVs) and vehicle-mounted relays.

The topic of service continuity has been addressed also in patent literature. WO 2022139216, incorporated herein by reference, relates to a cell reselection in wireless communications. The application discloses a method performed by a wireless device in a wireless communication system comprises: receiving information related to a service time of a neighbor cell; obtaining a cell quality of the neighbor cell based on a measurement on the neighbor cell; determining a remaining service time for the neighbor cell as a time period from a current time point to an end time point of the service time of the neighbor cell; and performing a cell reselection to the neighbor cell based on the cell quality of the neighbor cell and the remaining service time for the neighbor cell.

WO 2022086412 A1, incorporated herein by reference, discloses a method by a wireless device includes receiving, from a network node, data associated with the airborne or spaceborne system. The data includes satellite ephemeris data and a validity duration for the ephemeris data.

WO 2022079188 A1, incorporated herein by reference, discloses an apparatus for a wireless communication network is described that has an antenna unit. The antenna unit includes a plurality of antennas or one or more antenna arrays each having a plurality of antenna elements. The apparatus communicates with one or more network entities of the wireless communication network, like a base station or another UE. The apparatus transmits to or receives from the network entity a reference signal, like a Sounding Reference Signal, SRS, or a Synchronization Signal Block, SSB, using one or more beams beamformed by the apparatus using one or more input parameters. The apparatus transmits a feedback to the network entity, the feedback indicating the one or more input parameters the apparatus uses for beamforming the one or more beams, and/or the apparatus is configured or preconfigured, e.g., by the network entity, with the one or more input parameters.

WO 2022056786 A1, incorporated herein by reference, discloses a method comprises: determining, at a first device, an ordered list of target cells for a second device to initiate handover to in order based at least in part on location-related data of the second device, the second device being served in a source cell of the first device; transmitting, to the second device, first information indicating the ordered list of target cells and radio configurations associated with each of the target cells; and causing second information indicating the ordered list of target cells to be transmitted to at least one third device serving target cells in the ordered list, to request allocation of resources for the handover by the at least one third device. In this way, a chain of target cells regarding future handover is determined in a predetermined order, which avoid multiple cells prepare for a same handover, thus reducing handover preparation latency and improving the service continuity.

US 2022109496 A1, incorporated herein by reference, discloses aspects relate to mechanisms for wireless communication devices to update satellite and beam specific information. A user equipment (UE) selects a first cell associated with a first satellite for wireless communication in the non-terrestrial network. The UE determines whether to use one or more standard parameters or one or more satellite-cell specific parameters for accessing the first cell. The one or more standard parameters are based on one or more standard characteristics common to a plurality of satellites including the first satellite. The one or more satellite-cell specific parameters are based on a change to at least one standard characteristic of the one or more standard characteristics of the first satellite.

US 2022085874 A1, incorporated herein by reference, discloses a user equipment (UE) that selects or reselects a target cell of a non-terrestrial network or resumes connectivity with the target cell after a satellite handover for a permanently fixed low Earth orbit (LEO) cell. The target cell is a serving or non-serving cell. The UE determines a cell type of the target cell. The cell type may be a LEO cell type, a geostationary Earth orbit (GEO) cell type, a moving cell type, a fixed cell type, a temporarily fixed LEO cell type, or a permanently fixed LEO cell type. The UE completes selection or reselection of the target cell or completes the connectivity with the target cell, based on the cell type.

US 2022052753 A1, incorporated herein by reference, discloses a cellular network management system that manages terrestrial base station communications and orbital base station communications with user equipment to provide wireless service and allocate links among terrestrial base stations and orbital base stations according to base station availability determined from state space predictions.

To summarize, for earth-moving cell, the user equipment derives when loss of coverage of current cell happens. Prior art so far exhibit either implicit identification of cell type (earth-based versus space-based), explicit indication of terrestrial network (TN) coverage or iterative approaches for interference mitigation among transceivers.

### SUMMARY OF THE INVENTION

Therefore this application solves the problem of how to enable out-of-coverage prediction of earth-moving cells for mobility management and service continuity.

In particular this application gives a solution of how to determine when coverage of earth-moving non-terrestrial network (NTN) cells (including aerial platforms) will be lost and how to enable predictive mobility of aerial platforms or vehicle mounted relays and how to enable service continuity, if service is provided via earth moving non-terrestrial network cells (or aerial platforms) resulting in frequent connection transfers and therefore how to improve terrestrial-non-terrestrial network (TN-NTN) cell re-selection.

In accordance with an aspect of the disclosure, there is provided a method for enhanced mobility and service continuity based on beam pattern information in a wireless device, the wireless device being connected to a wireless network node, receiving from a mobile node a configuration message. The method comprises, in response to receiving at least one or more configuration message(s) from the wireless communication system, evaluating measurement criteria according to specific data comprising beam pattern, node type, reference location, trajectory and speed data. In response to the evaluation of measurement triggering criteria being verified: performing measurements according to the specific data, determining interference according to the specific data and transmitting measurement reports. In response to the evaluation of measurement triggering criteria not being verified: not transmitting measurement reports.

Main advantages of aspects of the inventions are the following:
reduced user equipment-specific signaling,
improved mobility support and service continuity,
reduced UE energy consumption and interference among mobile nodes,
enhanced coverage, and
optimized flight paths.

In some embodiments, the at least one or more configuration message(s) from the wireless communication system comprises measurement objects, events as well as corresponding beam-and location-specific triggering criteria. The wireless device performs and reports measurements according to received measurement configuration message, including triggering conditions related to the specific data of mobile node(s). The wireless device determines based on said triggering conditions, which relate to the specific data of mobile node(s), whether to transmit a measurement report or not. The measurements are related to received signal levels and frequencies as well as interference among signals received from at least one or multiple mobile nodes. The measurement triggering conditions are verified depending on the node type, location of wireless device with respect to specific beam(s) and node(s) of the wireless communication system, and beam-specific received signal level above a configured threshold.

In some embodiments, the measurement reports comprise node type data (namely aerial or ground wireless device), flight path/trajectory data (expressed by 3D waypoints, waypoint-specific timestamps), speed data (expressed by horizontal, vertical, orientation-dependent data), as well as beam-specific and interference-related measurement data.

Furthermore, in some embodiments, the mobile node broadcasts a beam pattern, wherein the beam pattern is adjustable. The beam pattern consists of angular beam range and/or angular directions of beam main lobes and/or beam tilting and/or granularity and/or use of specified beam pattern catalogue.

In some embodiments, the mobile nodes are mobile aerial nodes exchanging reference location and/or trajectory and/or speed and/or and beam pattern data for interference coordination.

Furthermore, a source and/or serving node(s) of the wireless communication system receiving measurement reports as report data from the wireless device determines, based on reported data, especially flight path data, whether the wireless device will enter their beam-specific coverage areas of at least one or more potential target nodes. The source and/or serving node of the wireless communication system forwards the reported data to the at least one or more potential target nodes during handover and/or conditional handover. The at least one or more potential target nodes of the wireless communication system configure handover and/or conditional handover commands based on received report data.

The at least one or more potential target nodes of the wireless communication system allocate grants for uplink data transmission of the wireless device as part of the handover and/or conditional handover commands. The at least one or more potential target nodes of the wireless communication system allocate resources for random access, such as random access occasions, back-off timer values, of the wireless device as part of the handover and/or conditional handover commands.

The disclosure further contemplates an apparatus for enhanced mobility and service continuity based on beam pattern information in wireless device, said apparatus comprising a processor coupled to a memory comprising computer program instructions stored thereon, said processor being configured by said instructions to perform the following acts: in response to receiving at least one or more configuration message(s) from the wireless communication system, evaluating measurement criteria according to specific data comprising beam pattern, node type, reference location, trajectory and speed data. In response to the evaluation of measurement triggering criteria being verified: performing measurements according to the specific data, determining interference according to the specific data and transmitting measurement reports. In response to the evaluation of measurement triggering criteria not being verified: not transmitting measurement reports.

The disclosure further contemplates a wireless device comprising an apparatus as described above. According to an embodiment, the wireless device performs service and/or connection time and mobility estimation.

The disclosure further contemplates a wireless network node comprising an apparatus as described above.

Another aspect of the disclosure relates to a wireless communication system comprising a wireless network node, a mobile network node and a wireless device, the wireless network node and the mobile network node configuring the wireless device as described hereinabove.

Yet another aspect of the disclosure relates to a computer program product comprising instructions for implementing a method for enhanced mobility and service continuity in a wireless device, when said program is executed by a processor.

A further aspect contemplates a computer-readable storage medium comprising computer program instructions for implementing steps of the method mentioned hereinabove.

The storage medium may be any entity or device capable of storing the program. For example, the medium can comprise a storage means, such as a ROM, for example a CD ROM or a microelectronic circuit ROM, FLASH memory or any magnetic recording means, for example a hard drive. Moreover, the information medium may be a transmissible medium such as an electrical or optical signal, which may be conveyed via an electrical or optical cable, by radio or by other means.

Alternatively, the storage medium may be an integrated circuit into which the program is incorporated, the circuit being adapted to execute or to be used in the execution of the methods in question.

The advantages of the apparatus, wireless device, network node, wireless system, computer program and storage medium are identical to those presented in relation with the corresponding method according to any one of the embodiments mentioned hereinabove.

### BRIEF DESCRIPTION OF THE DRAWINGS

The file of this patent contains at least one drawing executed in color. Copies of this patent with color drawing(s) will be provided by the Office upon request and payment of the necessary fee.

Other advantages and characteristics of aspects of the invention will be more clearly apparent on reading the following description, given by way of simple illustrative and nonlimiting example, and the appended drawings, among which:

FIG. 1 shows the context and relevance of an aspect of the invention to solve the problem,

FIG. 2 shows the NR Massive MIMO (prior art),

FIG. 3 shows the Integrated Access and Backhauling (IAB) reference architecture (prior art),

FIG. 4 shows Cell reselection enhancements (prior art),

FIG. 5 shows a network scenario with three dimensional moving nodes,

FIG. 6 shows the scenario with Network Topology and Interference Management and Mobility & Service Continuity Management,

FIG. 7 shows the scenario with Backhaul and Fronthaul,

FIG. 8 shows the Multi-Level Node Mobility (IAB) proposed in Release 17 (prior art)

FIG. 9 Depicts the Multi-level Node Mobility

FIG. 10 shows the architecture multi-Level Node Mobility (IAB) with node types

FIG. 11 shows the scenario of multi-Level Node Mobility (PC5 Relay)

FIG. 12 shows the problem of multi-Level Node Mobility (PC5 Relay)

FIG. 13 illustrates the concept underlying the method according to an aspect of invention,

FIG. 14 shows an embodiment of the invention, employing Uu Backhaul Link,

FIG. 15 shows an embodiment of the invention, employing Uu Fronthaul Link,

FIG. 16 shows an embodiment of invention, employing Application Triggered Re-Configuration,

FIG. 17 shows an embodiment of invention, employing Inter-Node Interference Coordination,

FIG. 18 shows an embodiment of the invention with RA Configuration,

FIG. 19 shows a further variant of an aspect of the invention with RA Configuration,

FIG. 20 shows an embodiment of invention, employing On Demand UE Request.

### DETAILED DESCRIPTION

The detailed description set forth below, with reference to annexed drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In particular, although terminology from 3GPP 5G NR may be used in this disclosure to exemplify embodiments herein, this should not be seen as limiting the scope of the invention.

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other aspects, features and advantages of the enclosed embodiments will be apparent from the following description.

The term “network node” is used and corresponds to any type of radio network node or any network node, which communicates with a UE (directly or via another node) and/or with another network node. Examples of network nodes are NodeB, MeNB, ENB, a network node belonging to MCG or SCG, base station (BS), multi-standard radio (MSR) radio node such as MSR BS, eNodeB, gNodeB, network controller, radio network controller (RNC), base station controller (BSC), relay, donor node controlling relay, base transceiver station (BTS), access point (AP), transmission points, transmission nodes, RRU, RRH, nodes in distributed antenna system (DAS), core network node (e.g. Mobile Switching Center (MSC), Mobility Management Entity (MME), etc.), Operations & Maintenance (O&M), Operations Support System (OSS), Self Optimized Network (SON), positioning node (e.g. Evolved-Serving Mobile Location Centre (E-SMLC)), Minimization of Drive Tests (MDT), test equipment (physical node or software), etc.

The term “mobile node” is used and corresponds to any type of moving node which communicates with a user equipment UE (directly or via another node) and/or with another network node, mobile or not. Examples of mobile nodes are satellite, aerial, low-/high altitude platform, drone, Uncrewed Aerial Vehicle, mobile Integrated Access and Backhaul node, Vehicle Mounted Relay.

The non-limiting term user equipment (UE) or wireless device is used and refers to any type of wireless device communicating with a network node and/or with another UE in a cellular or mobile communication system. Examples of UE are target device, device to device (D2D) UE, machine type UE or UE capable of machine to machine (M2M) communication, PDA, PAD, Tablet, mobile terminals, smart phone, laptop embedded equipped (LEE), laptop mounted equipment (LME), USB dongles, UE category MI, UE category M2, ProSe UE, V2V UE, V2X UE, etc.

Additionally, terminologies such as base station/gNodeB and UE should be considered non-limiting and do in particular not imply a certain hierarchical relation between the two; in general, “gNodeB” could be considered as device 1 and “UE” could be considered as device 2 and these two devices communicate with each other over some radio channel. And in the following the transmitter or receiver could be either gNodeB (gNB), or UE.

Explanations for the sake of understanding can be found in the Figures in textform.

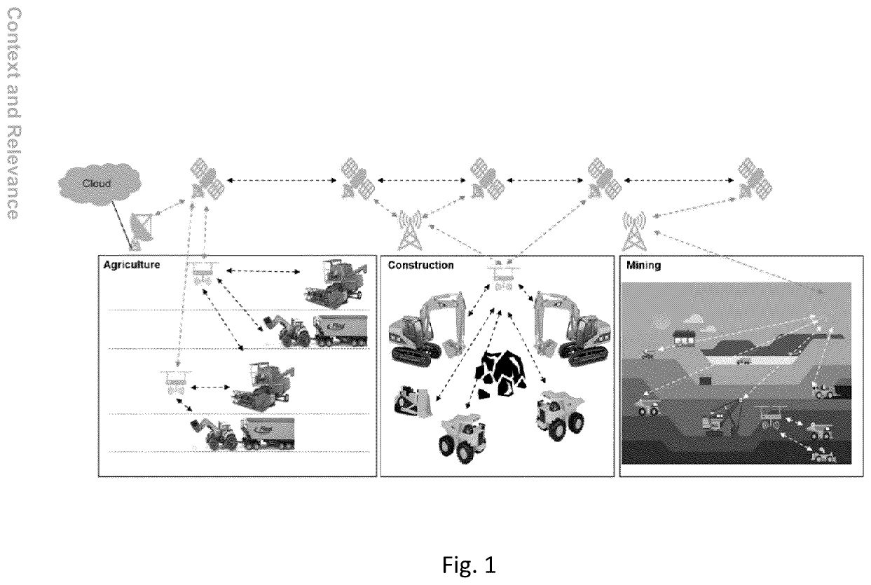

FIG. 1 shows the context and relevance of an aspect of the invention to solve the problem of poor or limited coverage in rural or remote areas, e.g., affecting use cases in agriculture, construction, mining, logistics, transportation, utilities.

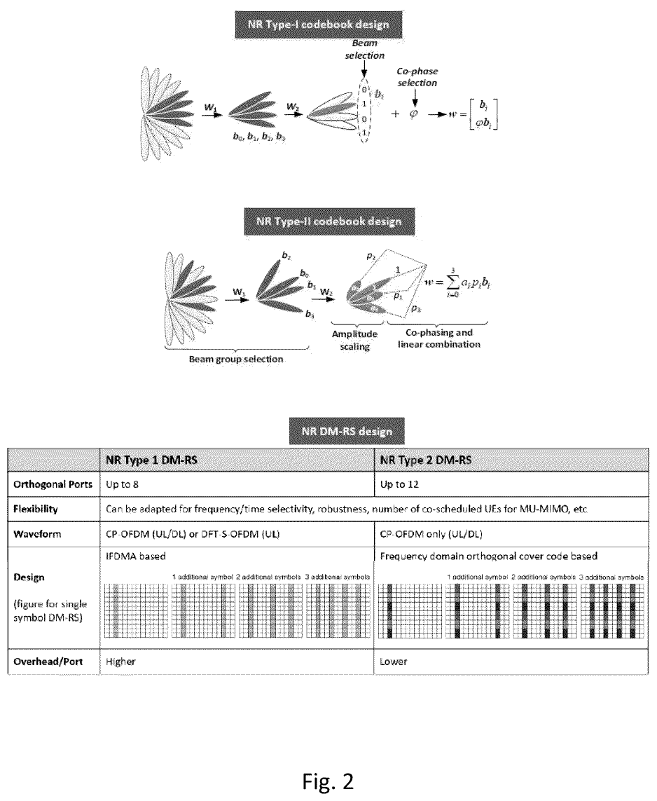

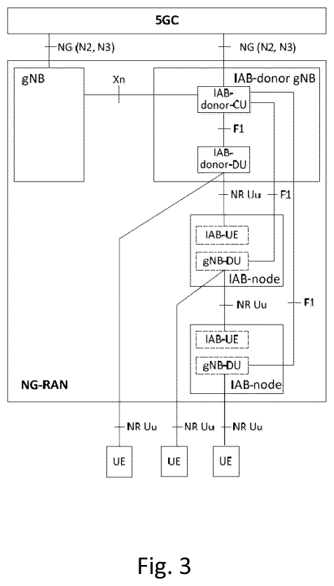

FIG. 2 shows the NR Massive MIMO design, as presented by Younsun Kim, Samsung, RWS-180008, «NR Physical Layer Design: NR MIMO». FIG. 3 shows the Integrated Access and Backhauling (IAB) reference architecture disclosed by 3GPP TS 23.501 Release 18.

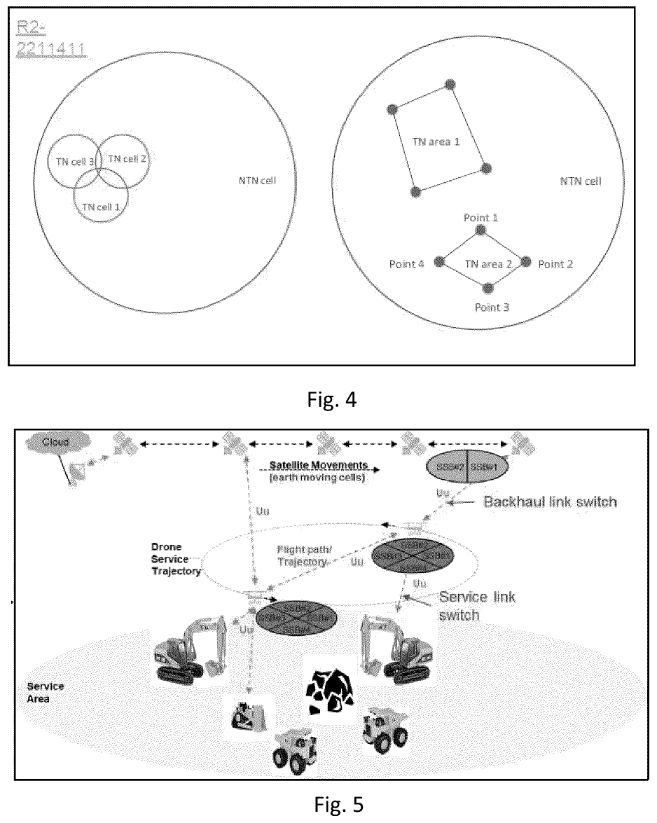

FIG. 4 shows cell reselection enhancements concept, where three terrestrial network cells are covered by a non-terrestrial network, each terrestrial network covering a respective service area defined by points.

FIG. 5 shows a network scenario with three dimensional moving nodes. According to the figure, a plurality of gound vehicles operating within a service area with poor or limited terrestrial wireless network coverage is served by a non-terrestrial network (NTN) employing satellites and mobile aerial nodes (e.g., drones following a known trajectory or flight path). Network access is provided to ground vehicles by means of backhaul link switches (between satellites and drones) and service link switches (between drones and ground vehicles).

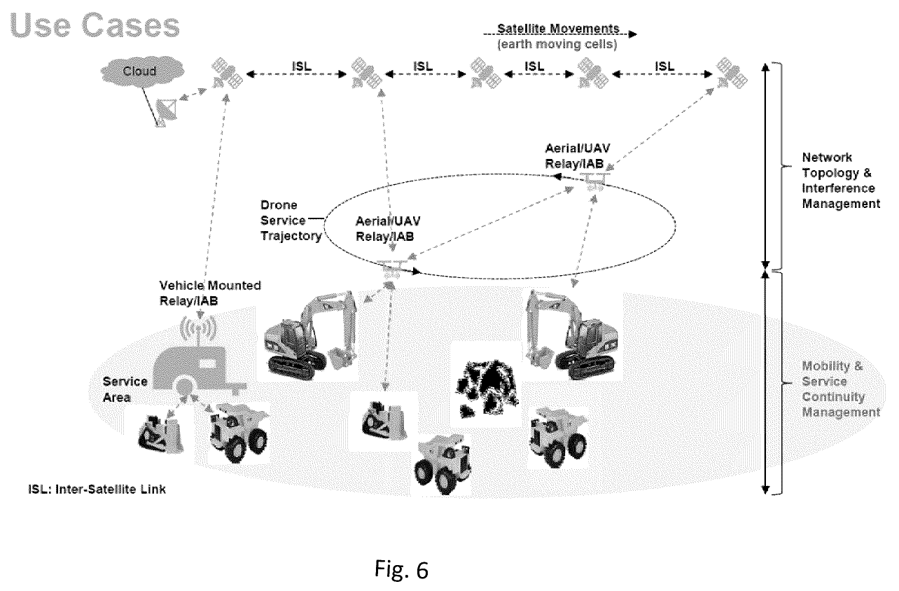

FIG. 6 shows the scenario with Network Topology and Interference Management and Mobility & Service Continuity Management. The assumptions for this particular scenario are that a least one ground vehicle is equipped with a user equipment that is capable to act as mobile relay (either a vehicle mounted relay or a mobile base station relay that uses integrated access and backhaul (IAB) architecture); NR Uu is used for the radio link between the mobile relay and the served ground vehicles (ruled by mobility and service continuity management protocol), as well as for the radio link between the mobile relay on the ground and satellites (ruled by network topology and interference management protocol).

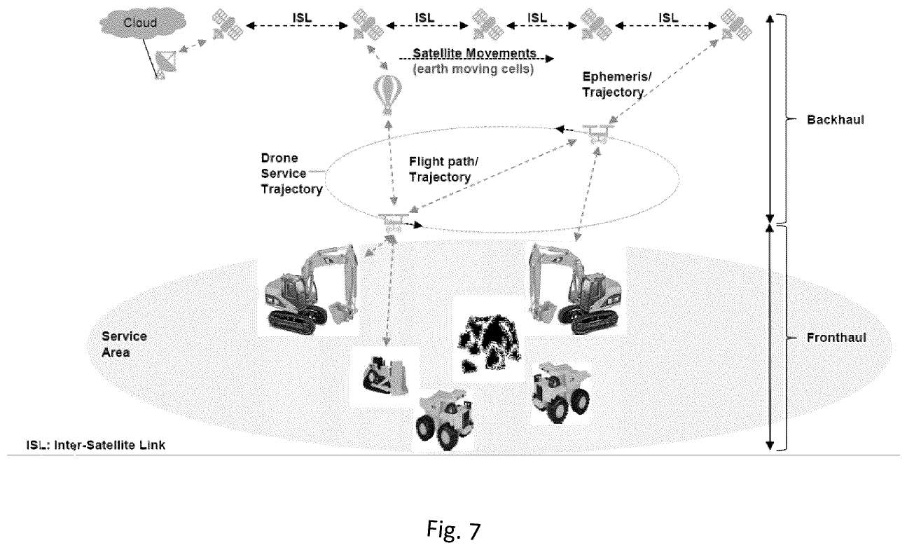

FIG. 7 shows the scenario with Backhaul and Fronthaul segments in a scenario where the mobile aerial nodes are employed at different altitudes, in this case a ballon is interposed between drone and satellites.

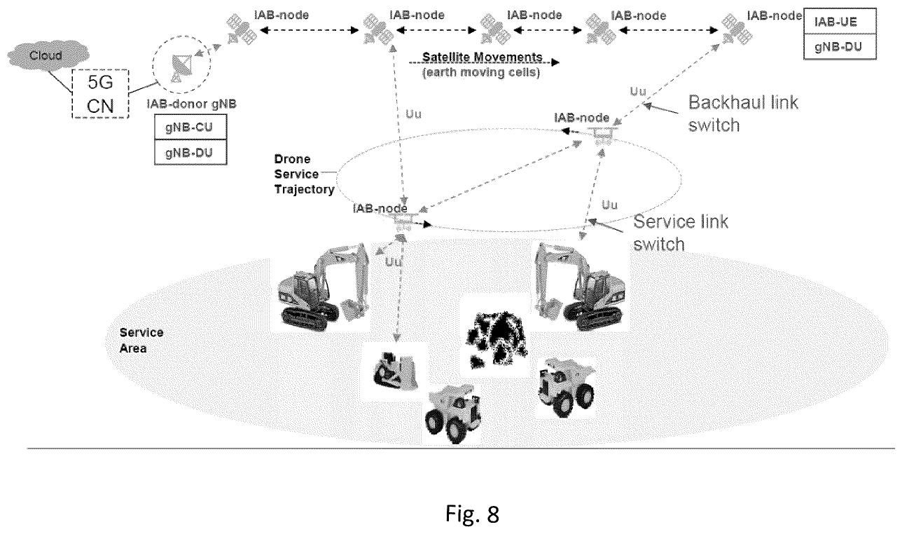

FIG. 8 shows the Multi-Level Node Mobility (IAB) proposed in Release 17 of the 3GPP, TS 23.501.

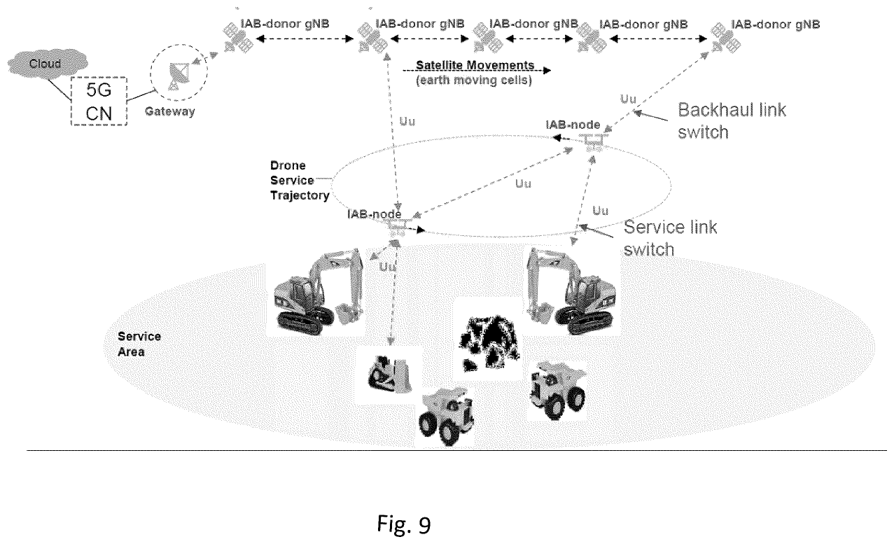

FIG. 9 depicts the multi-Level Node Mobility (IAB) proposed in Release 18 of the 3GPP, TS 23.501.

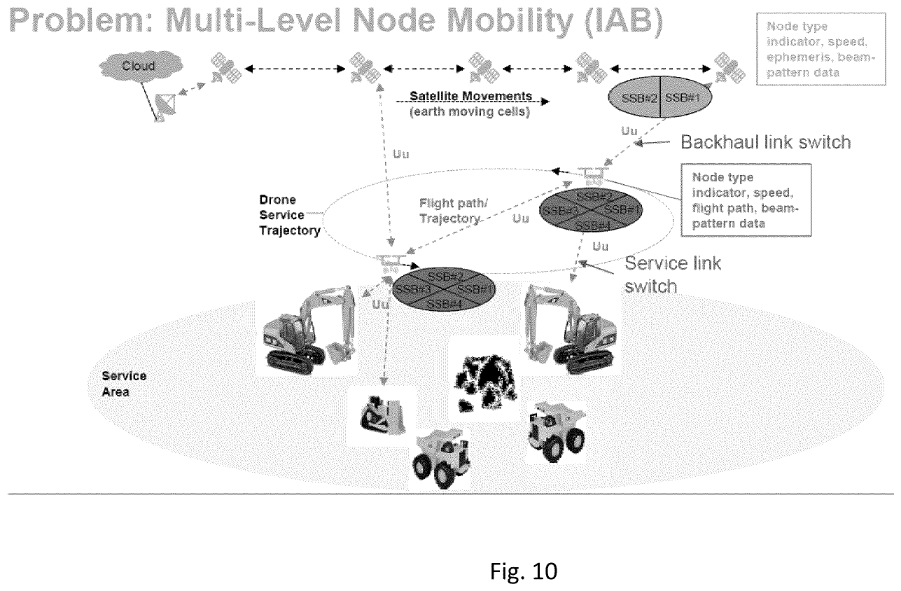

FIG. 10 shows the architecture multi-Level Node Mobility (IAB) with node types, where a set of specific data are exchanged, according to an embodiment of invention. The specific data are: node type indicator, speed, flight path, beam pattern data.

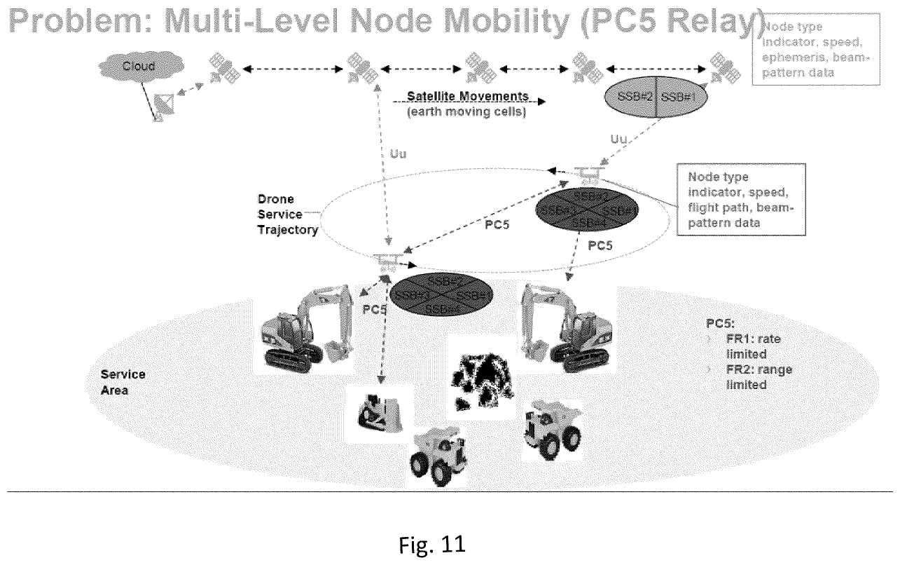

FIG. 11 shows the scenario of multi-level Node Mobility (PC5 Relay).

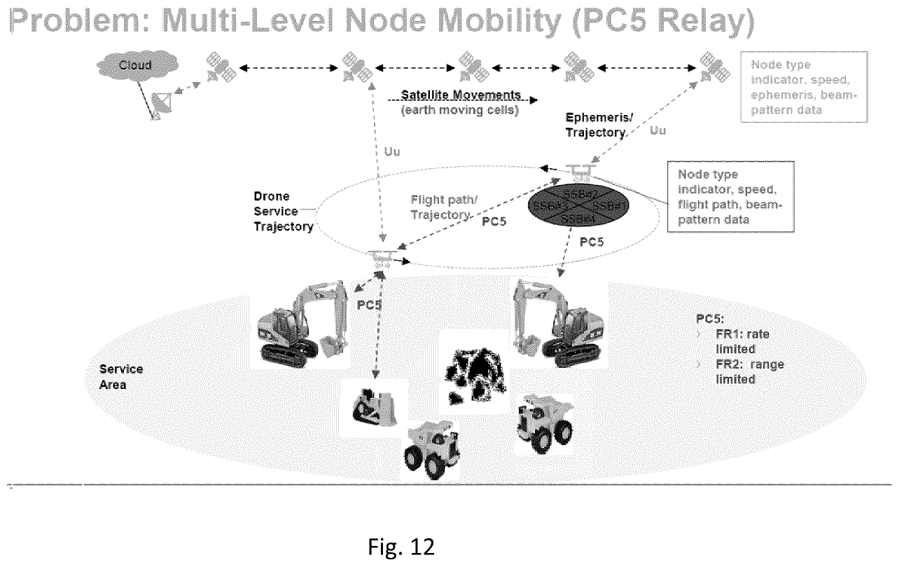

FIG. 12 shows the problem of multi-Level Node Mobility (PC5 Relay). The underlaying challenges are how to determine when coverage of earth-moving non-terrestrial network (NTN) cells (including aerial platforms) are lost? how to enable predictive mobility of aerial platforms or vehicle mounted relays? how to enable service continuity, if service is provided via earth moving non-terrestrial network cells (or aerial platforms) (resulting in frequent connection transfers)? and therefore how to improve terrestrial-non-terrestrial network (TN-NTN) cell re-selection.

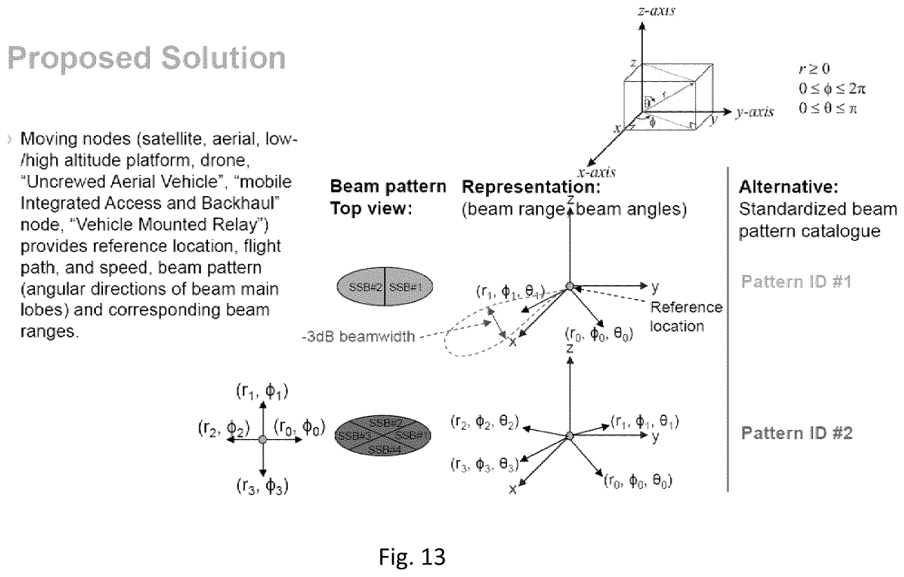

FIG. 13 illustrates the generic concept of an aspect of the invention: moving nodes provide node specific data including node type, reference location, flight path or trajectory, speed, beam pattern data.

Mobile node (e.g., satellite, aerial, low-/high altitude platform, drone, Uncrewed Aerial Vehicle, mobile Integrated Access and Backhaul node, Vehicle Mounted Relay) provides reference location (e.g., latitude, longitude, altitude, orientation), flight path (e.g., 3D waypoints, waypoint-specific timestamps), and speed (e.g., horizontal, vertical, orientation-dependent, similar to “ephemeris” data of satellites via SIB19) plus beam pattern data (angular directions of beam main lobes) and corresponding beam ranges. This set of data is called “node specific data”, or specific data.

Each node broadcasts a node type indicator (e.g., stationary ground node gNB, vehicle mounted (mobile) IAB node or relay, drone, LAPS, HAPS, LEO/MEO/GEO satellite) on service fronthaul and backhaul links, respectively.

Node broadcasts beam pattern (which is adjustable), expressed by means of e.g., angular beam range, angular directions of beam main lobes, beam tilting, granularity, use of specified beam pattern catalogue.

If in idle/inactive mode, UE receives this data as SIB.

If in active mode, serving node provides UE with beam-specific mobility (RRC re-configuration for CHO and cell/node reselection) as well as measurement configurations based on beam pattern data.

UE performs service/connection time and mobility estimation.

Mobile aerial nodes exchange reference location (expressed by coordinates in terms of altitude, longitude, latitude), flight path (or trajectory), speed (or velocity), and beam pattern data for interference coordination.

For multi-hop backhauling (involving multiple aerial nodes), the above info is exchanged and used for routing enhancements.

For switching between non-terrestrial and terrestrial networks (or vice versa) at terrestrial network coverage edge, beam-specific mobility configurations are provided to UE.

Aerial source node configures UE for radio access at aerial target node based on above info (e.g., set radio access occasion according to speed/velocity and predicted beam orientation).

Receiving node-specific data in advance can assist UE in beam alignment and improve QoS.

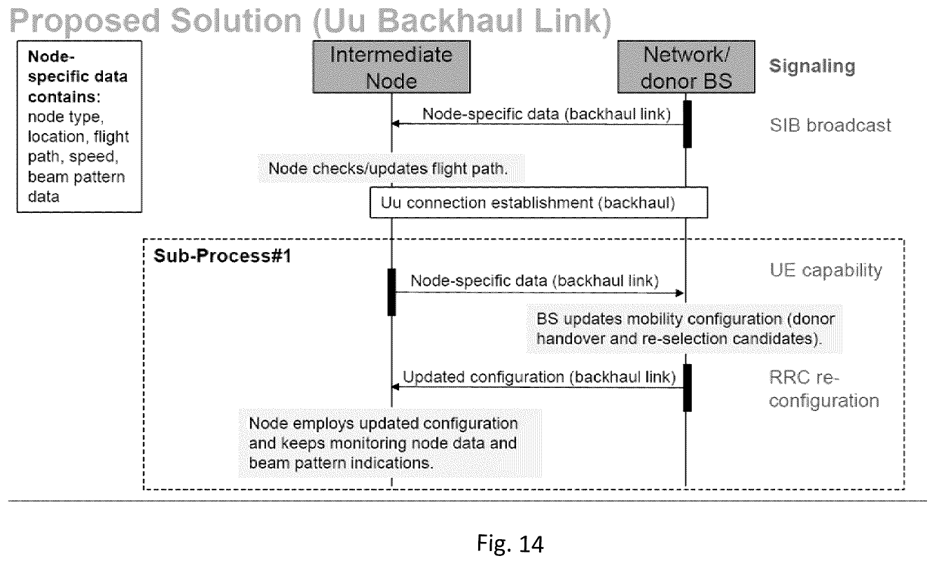

FIG. 14 shows an embodiment of invention with Uu Backhaul Link. Backhaul: IAB node receives ephemeris data (e.g., satellite) or node type, reference location, flight path, and speed, beam pattern and range from IAB donor node (BS). Check if flight path should be adjusted, e.g., to increase time under coverage of serving IAB donor node. Locations of ground vehicles/UEs, which need to be served, may limit the mobile IAB node's movements. IAB node provides network with intermediate node-specific node type, reference location, flight path, and speed, beam pattern data.

Network/BS updates mobility and measurement configurations (donor handover and re-selection candidates).

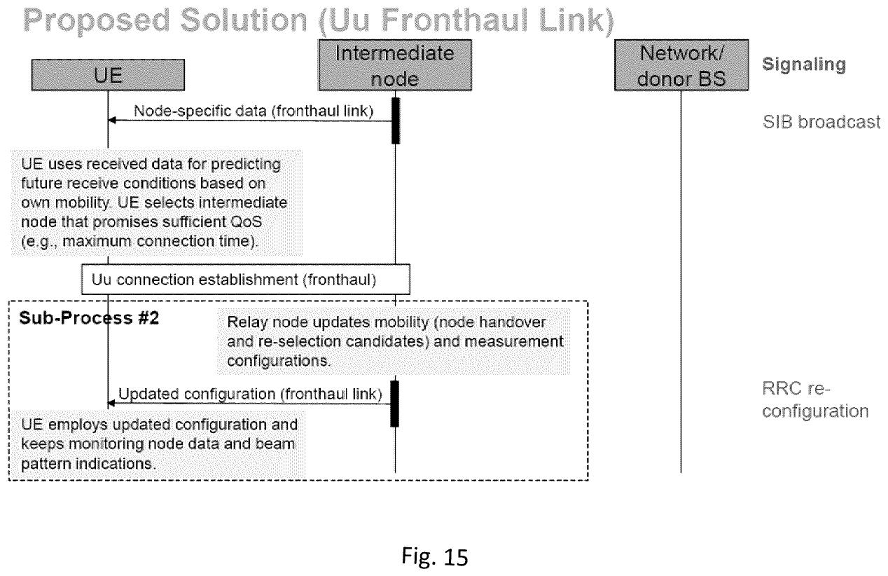

FIG. 15 shows an embodiment of invention with Uu Fronthaul Link. Fronthaul: Network/BS updates mobility and measurement configurations (donor handover and re-selection candidates). Network/BS determines radio access resources (e.g., RACH resources, back-off values, RA occasions) for aerial node candidates. UE receives updated mobility, radio access, and measurement configurations from intermediate (IAB, relay) node. UE receives node type, reference location, flight path, and speed, beam pattern data from intermediate (IAB, relay) node. If PC5: UE selects relay node that promises sufficient QoS (e.g., maximum connection time). Otherwise, UE connects to best cell/node candidate. Application layer triggers flight path and/or beam pattern updates.

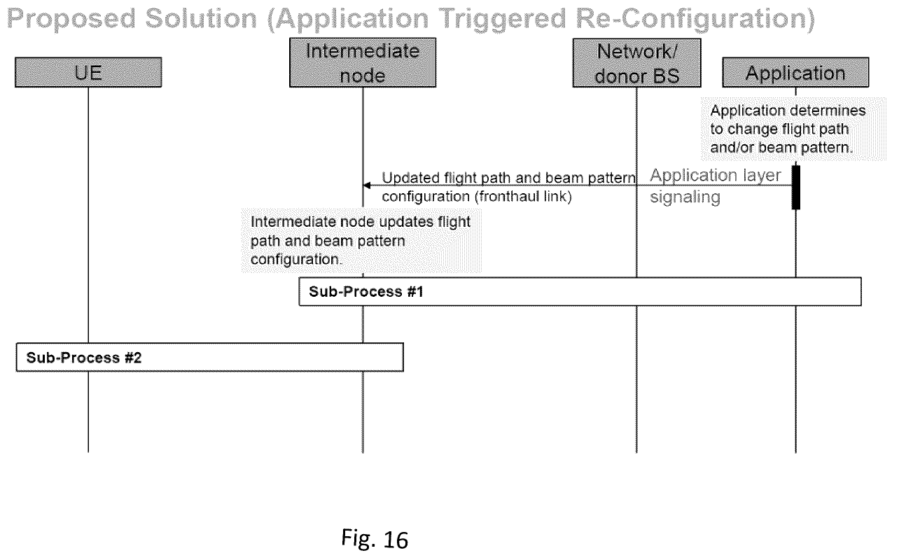

FIG. 16 shows an embodiment of invention of Application Triggered Re-Configuration. Changing flight path depends on “mission” configured on application layer; beam pattern is configured also on application layer. Therefore, application layer signals updated flight path and beam pattern configurations by means of fronthaul link to relay node. The intermediate node updates flight path and beam pattern configuration.

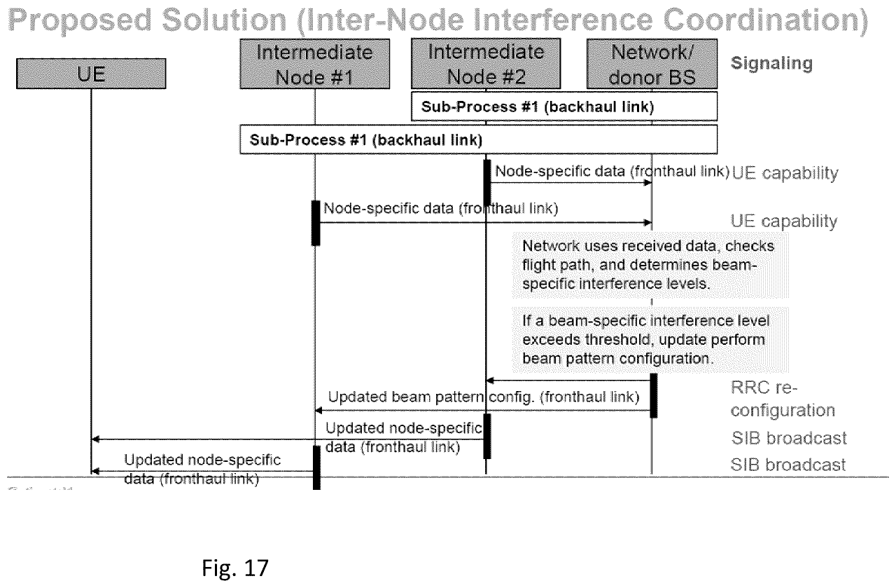

FIG. 17 shows the Inter-Node Interference Coordination, when multiple intermediate nodes are employed.

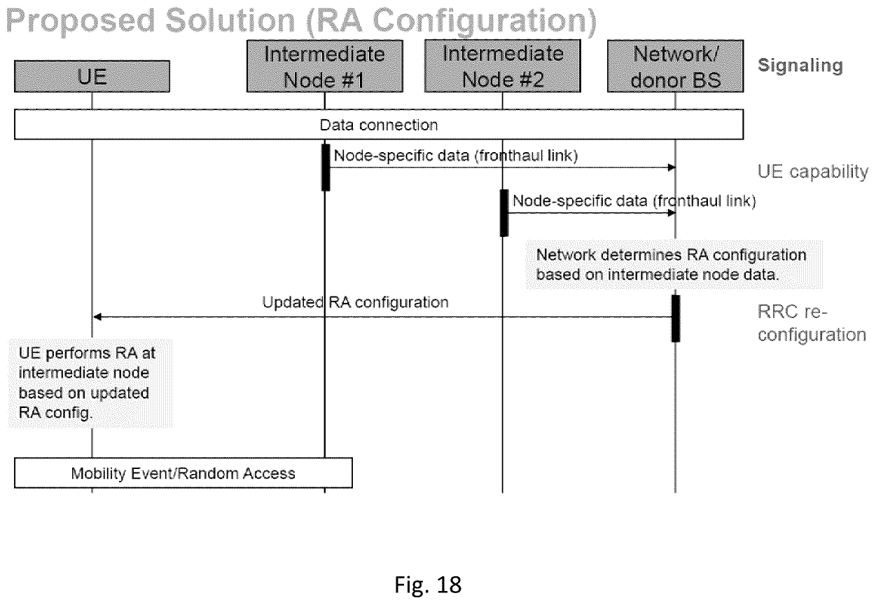

FIG. 18 shows an embodiment of invention with radio access configuration. In response to receiving a connection setup message from the network, the mobile aerial nodes provide the network their respective node specific data via fronthaul link. In response to receiving node-specific data, the network determines radio access configuration based on the received node specific data, and updates radio access configuration. UE receives the updated radio access configuration, and performs radio access accordingly, and initiate mobility event or random access procedure.

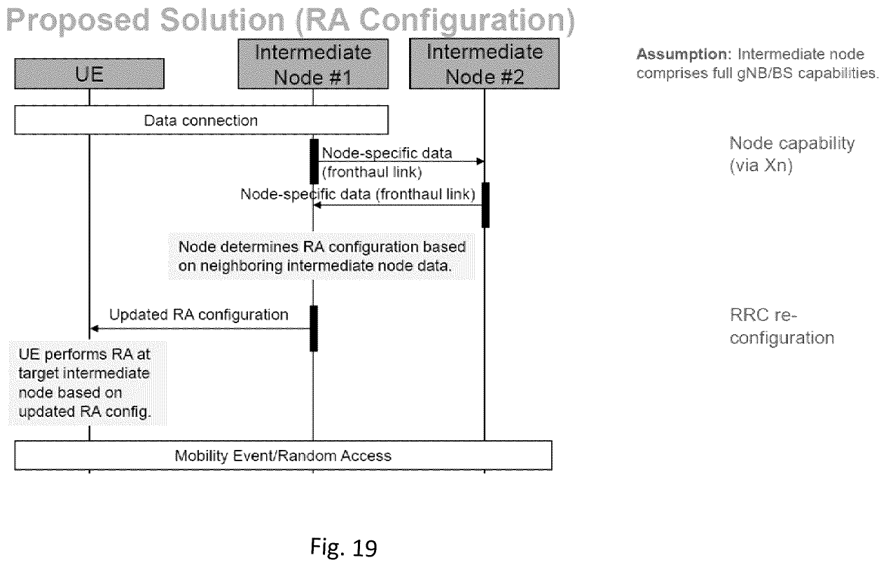

FIG. 19 shows a further embodiment of invention with radio access configuration, under the assumption that the moving node comprises full ground node or base station capabilities. In this case, the network determined radion access configuration based on neighboring moving nodes data.

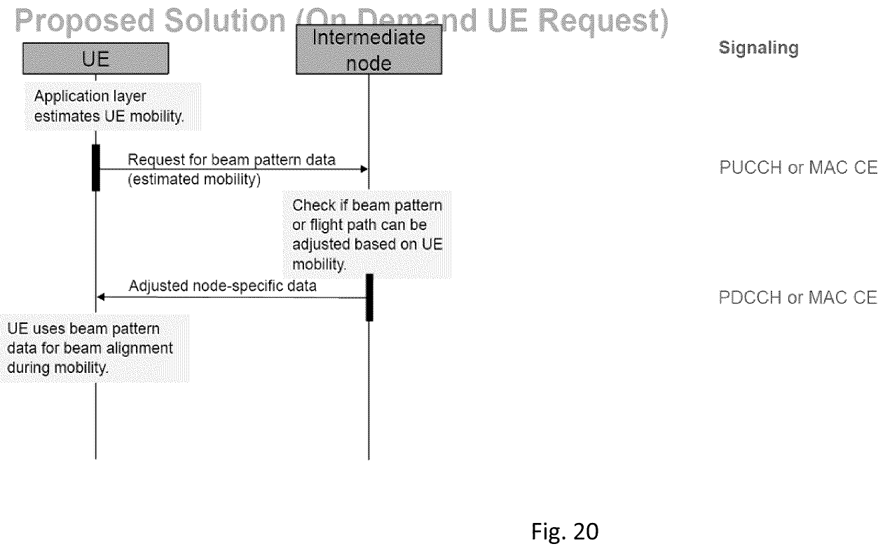

FIG. 20 shows an embodiment of invention for On Demand UE Request. At UE, the application layer estimates UE mobility and provides UE with estimated mobility, UE sends a request for beam pattern data to the moving node to match the estimated mobility. In response to receiving the request and estimated UE mobility, the moving node checks if beam pattern or flight path has to be adjusted, and sends back the adjusted node-specific data (including the adjusted beam pattern and flight path). After receiving the adjusted node specific data, UE uses beam pattern data for beam alignment.

Some benefits of this invention are i.e the use fo node-specific data (node type, location, flight path, speed, beam pattern data) for service continuity as follows: Network only configures candidate cells (re-selection and/or (conditional) handover), if estimated connection time is larger than a predetermined time (time threshold being provided as part of network configuration). Network determines RA resources (e.g., RACH resources, back-off values, RA occasions) for node candidates. Otherwise, network sets “cell barring info” or as “low priority” cell/node candidate. Estimated connection time (and thus, threshold configured) is enhanced by considering service type or quality of service QoS. Knowing flight path and beam pattern threshold configuration, and thus, connection time to mobile IAB/relay node is optimized.

The use above info for measurement enhancements means UE determines/optimizes candidate list measurement reporting based on indicated flight path and beam pattern. UE performs measurements, only if mobile IAB/relay nodes are in range.

Other benefits of this application are seen: as if flight path/trajectory is known/predictable and beam pattern is shared, adjustable beam patterns and indications provide more deployment flexibility and potential optimizations, SIB broadcast means reduced UE-specific signaling, relay/cell candidate configuration (including radio access RA) and thus, service continuity (Quality of Service) are improved, measurement reporting is improved, therefore reduced UE energy consumption.

Knowledge/sharing of satellite beam patterns help aerial IAB nodes/relays to minimize interference, enhance coverage, and optimize flight paths.

High costs for building and deploying private mobile network infrastructure are avoided by using aerials, UAVs, vehicle mounted relays or mobile IAB nodes for providing local connectivity.

Not having to equip each vehicle with an non-terrestrial network NTN-capable on-board unit and corresponding antennas results in BOM savings. Non-NTN-capable connects via mobile IAB/relay node to (satellite) network.

1. A method of wireless communications in a wireless communication system, the method being implemented by a wireless device of the wireless communication system, wherein the wireless device comprises a communication unit configured to exchange data with a radio access network (RAN), of the wireless communication system, wherein the method comprises, in response to receiving at least one or more configuration message(s) from the wireless communication system:
evaluating measurement criteria according to specific data comprising beam pattern, node type, reference location, trajectory and speed data, in response to the evaluation of measurement triggering criteria being verified:
performing measurements according to the specific data,
determining interference according to the specific data
transmitting measurement reports, and
in response to the evaluation of measurement triggering criteria not being verified: not transmitting measurement reports.

2. The method according to claim 1, wherein the at least one or more configuration message(s) from the wireless communication system comprises measurement objects, events as well as corresponding beam-and location-specific triggering criteria.

3. The method according to claim 1 wherein the mobile node broadcasts a beam pattern, wherein the beam pattern is adjustable.

4. The method according to claim 1 wherein the beam pattern consists of angular beam range and/or angular directions of beam main lobes and/or beam tilting and/or granularity and/or use of specified beam pattern catalogue.

5. The method according to claim 1, wherein mobile nodes are mobile aerial nodes and exchanging reference location and/or trajectory and/or speed and/or and beam pattern data for interference coordination.

6. The method according to claim 1, wherein the wireless device performs service and/or connection time and mobility estimation.

7. The method according to claim 1, wherein wireless device performs and reports measurements according to received measurement configuration message, including triggering conditions related to the specific data of mobile node(s).

8. The method according to claim 1, wherein wireless device determines based on said triggering conditions, which relate to the specific data of mobile node(s), whether to transmit a measurement report or not.

9. The method according to claim 1, wherein measurements are related to received signal levels and frequencies as well as interference among signals received from at least one or multiple mobile nodes.

10. The method according to claim 1, wherein the measurement triggering conditions are verified depending on the node type, location of wireless device with respect to specific beam(s) and node(s) of the wireless communication system, and beam-specific received signal level above a configured threshold.

11. The method according to claim 1, wherein the measurement reports comprise node type data, namely aerial or ground wireless device.

12. The method according to claim 1, wherein the measurement reports comprise node type data, namely aerial or ground wireless device.

13. The method according to claim 1, wherein the measurement reports comprise flight path/trajectory data expressed by 3D waypoints, waypoint-specific timestamps.

14. The method according to claim 1, wherein the measurement reports comprise speed data expressed by horizontal, vertical, orientation-dependent data.

15. The method according to claim 1, wherein the measurement reports comprise as well as beam-specific and interference-related measurement data.

16. The method according to claim 1, wherein a source and/or serving node(s) of the wireless communication system receiving measurement reports as report data from the wireless device determines, based on reported data, especially flight path data, whether the wireless device will enter their beam-specific coverage areas of at least one or more potential target nodes.

17. The method according to claim 1, wherein the source and/or serving node of the wireless communication system forwards the reported data to the at least one or more potential target nodes during handover and/or conditional handover.

18. The method according to claim 1, wherein the at least one or more potential target nodes of the wireless communication system configure handover and/or conditional handover commands based on received report data.

19. The method according to claim 1, wherein the at least one or more potential target nodes of the wireless communication system allocate grants for uplink data transmission of the wireless device as part of the handover and/or conditional handover commands.

20. The method according to claim 1, wherein the at least one or more potential target nodes of the wireless communication system allocate resources for random access, such as random access occasions, back-off timer values, of the wireless device as part of the handover and/or conditional handover commands.

21. An apparatus for enhanced mobility and service continuity in a wireless device connected to a wireless network node, said communication unit comprising a processor coupled to a memory comprising computer program instructions stored thereon, said processor being configured by said instructions to perform the following the method according to claim 1.

22. A wireless device comprising an apparatus according to claim 21.

23. A wireless network node comprising an apparatus for enhanced mobility and service continuity in a wireless device connected to a wireless network node, said communication unit comprising a processor coupled to a memory comprising computer program instructions stored thereon, said processor being configured by said instructions to perform the method according to claim 1.

24. A mobile node connected to a wireless network node, comprising an apparatus for enhanced mobility and service continuity in a wireless device connected to a wireless network node, said communication unit comprising a processor coupled to a memory comprising computer program instructions stored thereon, said processor being configured by said instructions to perform the method according to claim 1.

25. The mobile node according to claim 24, that broadcasts the specific data on service/fronthaul and backhaul links.

26. The mobile node according to claim 24, wherein the mobile node is a drone, high altitude platform station (HAPS), uncrewed aerial vehicle (UAV), satellite, vehicle mounted relay, mobile relay, mobile base station relay with integrated and access backhaul node (MBSR-IAB).

27. (canceled)

28. A computer program product comprising instructions for implementing the method in a wireless device according to claim 22, when said program is executed by a processor.

29. A non-transitory computer-readable storage medium comprising computer program instruction stored thereon for implementing a method for enhanced mobility and service continuity instructions for implementing a method for enhanced mobility and service continuity in a wireless device according to claim 22.

30. A computer program product comprising instructions for implemented a method according to claim 1, when said program is executed by a processor.
